(19) United States
(12) Patent Application Publication
(10) Pub. No.: US 2026/0326178 A1
(43) Pub. Date: Oct. 22, 2026

(54) Fracturing-Enhanced Biodegradation Remediation System and Method for Low-Permeability Contaminated Formations

(71) Applicant: Tongji University, Shanghai (CN)

(72) Inventors: Shijin FENG, Shanghai (CN); Jinhui SHU, Shanghai (CN); He CHEN, Shanghai (CN); Qiteng ZHENG, Shanghai (CN); Hongxin CHEN, Shanghai (CN)

(73) Assignee: Tongji University, Shanghai (CN)

(21) Appl. No.: 19/649,089

(22) Filed: Apr. 15, 2026

(30) Foreign Application Priority Data
Apr. 16, 2025 (CN) 202510475942.3

(51) Int. Cl. B09C 1/10

(52) U.S. Cl. CPC B09C 1/10; B09C 2101/00

(57) ABSTRACT

A fracturing-enhanced biodegradation remediation system and method for low-permeability contaminated formations. The remediation system comprises a casing, a hydraulic fracturing device, a biological agent injection device, a cross resistivity monitoring device, a pH driving device, a thermal resistance driving device, and an online monitoring and control system. The hydraulic fracturing device is configured to create fractures in soil to provide passages for delivery of a biological agent. The biological agent injection device is configured to deliver the biological agent through the fractures to contaminated soil. The cross resistivity monitoring device is configured to monitor resistivity changes in real time to adjust an injection amount and an injection process of the biological agent. The pH driving device and the thermal resistance driving device are respectively used to change soil pH and temperature. The online monitoring and control system is connected to the above five devices.

### CROSS-REFERENCE

This application claims the benefit of priority from China Patent Application No. CN 202510475942.3 filed on Apr. 16 2025, the contents of which are hereby incorporated by reference in their entirety.

### TECHNICAL FIELD

The present invention belongs to the technical field of soil and groundwater contamination remediation, and specifically relates to a biodegradation remediation method for low-permeability sites, and more particularly to an environmentally driven, fracturing-enhanced and biodegradation remediation technology with online monitoring and control.

### BACKGROUND TECHNOLOGY

Currently, in-situ remediation methods such as chemical oxidation, multiphase extraction, and biodegradation remediation are mainly used. Among these: chemical oxidation technology achieves contaminant degradation by injecting chemical agents that react with organic contaminants. However, the extensive use of chemical agents can easily cause secondary soil contamination. Multiphase extraction involves extracting groundwater carrying contaminants and removing the contaminants through elution, adsorption, and other processes. This technique suffers from drawbacks such as complicated treatment procedures, slow remediation speed, high cost, and poor remediation effectiveness. Biodegradation remediation degrades organic contaminants into harmless inorganic substances. With its advantages of low cost, simple remediation process, and no secondary contamination, it is being increasingly widely applied to various contaminated sites. Nevertheless, contaminated sites in coastal cities often exhibit low-permeability characteristics. The high compactness of low-permeability clay severely hinders the large-scale injection of remediation agents. The only option is to rely on the inherent permeability of microbial flora to migrate to deeper contaminated areas. However, the migration speed of the flora itself is limited, resulting in insufficient contact between the remediation agent and the contaminated soil, which in turn leads to problems such as a small remediation range and poor remediation effectiveness. Current biodegradation remediation technology faces two major issues. On the one hand, due to the concealment and complexity of subsurface structures in low-permeability contaminated sites, it is impossible to effectively regulate and control the bioremediation process in the subsurface space. It is difficult to determine parameters such as the injection rate and injection volume of the biological agent. Real-time monitoring of remediation degradation effectiveness and adjustment of the remediation process based on monitoring results are not feasible. Moreover, microorganisms are strongly dependent on their living environment, and the variability of the subsurface environment limits microbial activity. Environmentally driven approaches are needed to enhance microbial activity, thereby accelerating microbial decomposition of contaminants. On the other hand, when traditional resistivity monitoring methods are applied to surface monitoring, electrodes can be easily inserted into the soil on the ground surface, making the monitoring results stable and reliable. However, when the resistivity method is used to monitor resistivity changes in deeper subsurface zones, electrodes must be installed in monitoring wells to perform cross-hole measurements to meet the depth requirements. Installing electrodes in narrow monitoring wells has become a major challenge. It is difficult to insert and extract the electrodes. Poor contact between the electrodes and the soil often occurs due to insufficient electrode insertion, which severely affects the monitoring of remediation effectiveness. Furthermore, after use, the electrodes are difficult to extract and reuse, leading to increased remediation costs and resource waste. There is an urgent need to solve the problems of electrode insertion in the remediation monitoring system and the recyclability of the monitoring apparatus.

### SUMMARY OF THE INVENTION

In view of the shortcomings of the prior art, the present invention provides a fracturing-enhanced biodegradation remediation system and method for low-permeability contaminated formations. By using a cross resistivity monitoring device under environmental driving conditions, the injection of biological agent and the remediation process are dynamically regulated. Furthermore, an electrode retraction/extending device and a reaction force tensioning device are employed to achieve reusability of key components of the remediation system, thereby achieving green, economical, and efficient remediation.

To achieve the above objectives, the technical solutions of the present invention are as follows:

### Technical Solution 1

A fracturing-enhanced biodegradation remediation system for low-permeability contaminated formations, comprising a casing (1), a hydraulic fracturing device, a biological agent injection device, a cross resistivity monitoring device, a pH driving device, a thermal resistance driving device, and an online monitoring and control system (13), wherein:
the casing (1) is disposed in soil of a contaminated site for preventing collapse of soil near a borehole, and a plurality of holes are opened on the casing (1) for use as injection passages for fracturing fluid, biological agent, and pH adjusting liquid; the hydraulic fracturing device is configured to create fractures in the soil to provide passages for delivery of the biological agent;
the biological agent injection device is configured to deliver the biological agent through the fractures to contaminated soil;
the cross resistivity monitoring device is configured to monitor resistivity changes in real time to adjust an injection amount and an injection process of the biological agent;
the pH driving device is configured to change the pH of the soil, and the thermal resistance driving device is configured to adjust the temperature of the soil, wherein microbial activity and reproduction speed are increased by the pH driving device and the thermal resistance driving device, thereby accelerating microbial decomposition of organic contaminants;
the online monitoring and control system (13) is connected to the hydraulic fracturing device, the biological agent injection device, the cross resistivity monitoring device, the pH driving device, and the thermal resistance driving device, and monitors and controls operation of the entire remediation system online.

### Technical Solution 2

A fracturing-enhanced biodegradation remediation system for low-permeability contaminated formations, comprising a casing (1), a hydraulic fracturing device, a biological agent injection device, a cross resistivity monitoring device, a pH driving device, a thermal resistance driving device, an online monitoring and control system (13), and further comprising a well pipe (2), an electrode retraction/extending device (4), and a reaction force tensioning device (5), wherein:
the casing (1) is disposed in soil of a contaminated site for preventing collapse of soil near a borehole, and a plurality of holes are opened on the casing (1) for use as injection passages for fracturing fluid, biological agent, and pH adjusting liquid; the hydraulic fracturing device is configured to create fractures in the soil to provide passages for delivery of the biological agent;
the biological agent injection device is configured to deliver the biological agent through the fractures to contaminated soil;
the cross resistivity monitoring device is configured to monitor resistivity changes in real time to adjust an injection amount and an injection process of the biological agent;
the pH driving device is configured to change the pH of the soil, and the thermal resistance driving device is configured to adjust the temperature of the soil, wherein microbial activity and reproduction speed are increased by the pH driving device and the thermal resistance driving device, thereby accelerating microbial decomposition of organic contaminants;
the online monitoring and control system (13) is connected to the hydraulic fracturing device, the biological agent injection device, the cross resistivity monitoring device, the pH driving device, and the thermal resistance driving device, and monitors and controls operation of the entire remediation system online;
the well pipe (2), the electrode retraction/extending device (4), and the reaction force tensioning device (5) are used for lowering electrodes of the cross resistivity monitoring device to appropriate positions in underground boreholes, enabling insertion and extraction of the electrodes into and from the soil.

### Technical Solution 3

A fracturing-enhanced biodegradation remediation method for low-permeability contaminated formations, implemented based on the remediation system of Technical Solution 1 or Technical Solution 2, wherein the implementation process comprises the following steps:
Step one: drilling a borehole and completing a well;
Step two: installing main components of the remediation system;
Step three: performing hydraulic fracturing by using the hydraulic fracturing device; ensuring that a fracturing fluid injection pipe (802) is connected to a fracturing spray hole (101), turning on a hydraulic fracturing injection pump (801) of the hydraulic fracturing device by the online monitoring and control system (13), injecting high-pressure water at the fracturing spray hole (101) to perform hydraulic fracturing, forming a fracture (3) near the fracturing spray hole (101), and delivering a proppant into the fracture to form an agent injection passage to prevent the fracture from closing;
Step four: performing cross-hole resistivity monitoring by using the cross resistivity monitoring device;
connecting all electrodes (703) in two underground wells respectively to an electrode line interface (702) of the cross resistivity monitoring device, connecting a mobile power supply (704) and a resistivity monitoring controller (701), controlling, by the online monitoring and control system (13), any two electrodes in the two underground wells to supply current, and the remaining any two electrodes to measure voltage, calculating a resistivity of an area between the two underground wells according to a resistivity testing principle, and monitoring once at fixed time intervals, performing continuous online monitoring;
Step five: injecting remediation agent by using the biological agent injection device; preparing a mixed liquid of a microbial agent and a growth promoter, ensuring that a biological agent injection pipe (602) is connected to a biological agent injection hole (102), turning on a biological agent injection pump (601) by the online monitoring and control system (13), injecting the microbial remediation agent through the biological agent injection pipe (602) into a fracture (3), performing resistivity monitoring based on the relationship between the microbial injection amount and the resistivity change, and using the online monitoring and control system (13) to regulate the microbial injection amount and injection rate;
Step six: achieving pH and temperature environment driving by using the pH driving device and the thermal resistance driving device;
obtaining a contaminant decomposition rate and a remediation area according to resistivity monitoring results fed back by the online monitoring and control system (13), using the online monitoring and control system (13) to control a temperature sensor (1003) of the thermal resistance driving device and a pH sensor (903) of the pH driving device to respectively test ambient temperature and pH at a fracture (3), and according to pH and temperature suitable for microbial survival, turning on, by the online monitoring and control system (13), the thermal resistance driving device and the pH driving device to adjust soil temperature and pH, thereby increasing microbial activity, accelerating microbial decomposition of organic contaminants, improving remediation efficiency, and expanding a remediation range;
Step seven: performing integrated collaborative work of resistivity monitoring, bioremediation, and environment driving;
Step eight: recovering the remediation system;
Step nine: reinstalling the remediation system in a next borehole to carry out bioremediation.

With the above solutions, the present invention achieves the following beneficial effects:

The fracturing-enhanced biodegradation remediation system for low-permeability contaminated formations of the present invention has the advantages of simple structure, low cost, strong controllability, wide remediation range, and precise remediation.

Aiming at the problems of low permeability of low-permeability contaminated formations, difficulty in effectively injecting and controlling remediation agents, and high remediation cost and low efficiency, the present invention proposes an integrated control system combining fracturing enhancement, biodegradation remediation, environment driving, and real-time remediation monitoring. The resistivity information fed back by the cross resistivity monitoring device is used to guide the biological agent injection device. The injection amount and injection rate of the agent are precisely controlled through the relationship between the microbial injection amount M and the resistivity change, effectively avoiding problems such as insufficient or excessive agent injection, thereby greatly saving remediation costs.

The dual environment driving devices, i.e., the pH driving device and the thermal resistance driving device, are used to change the soil environment. The temperature sensor and the pH sensor measure the soil temperature and pH in the contaminated area. Since microorganisms exhibit good degradation capacity and activity in the temperature range of 20-35 °C and the pH range of 6-8, the pH driving device and the thermal resistance driving device adjust the environmental conditions of the microorganisms, enhance microbial activity, accelerate microbial decomposition of contaminants over a larger contamination range, and effectively improve injection effectiveness and remediation efficiency.

Furthermore, the cross resistivity monitoring device, by employing the electrode retraction/extending device and the reaction force tensioning device, can insert electrodes into deeper contaminated soil in narrow underground boreholes (also referred to as underground wells), allowing the electrodes to make good contact with the soil to form a stable electric field. The resistivity measurement data become more stable and reliable, facilitating accurate monitoring and refined control of the microbial remediation process. In addition, the electrode retraction/extending device and the reaction force tensioning device enable reusability of the cross resistivity monitoring device. After remediation is completed, the electrodes and the well pipe can be extracted, and the recovered apparatus can be placed into the next underground well for continued use in remediation monitoring, saving substantial remediation costs and effectively solving the problems of electrode insertion and electrode reusability in narrow underground boreholes.

### BRIEF DESCRIPTION OF THE DRAWINGS

FIG. 1 is a schematic structural and scenario diagram of a fracturing-enhanced biodegradation remediation system for low-permeability contaminated formations according to Embodiment 1.

FIG. 2 is a schematic structural diagram of a cross resistivity monitoring device according to Embodiment 1.

FIG. 3 is a schematic structural diagram of a pH driving device and a thermal resistance driving device according to Embodiment 1.

FIG. 4 is a schematic structural diagram of an online monitoring and control system according to Embodiment 1.

FIG. 5 is a schematic workflow diagram of the online monitoring and control system according to Embodiment 1.

FIG. 6 is a schematic diagram showing a relationship between contaminant concentration and resistivity according to Embodiment 1.

FIG. 7 is a schematic structural and scenario diagram of a fracturing-enhanced biodegradation remediation system for low-permeability contaminated formations according to Embodiment 2.

FIG. 8 is a schematic structural diagram of an electrode retraction/extending device and a reaction force tensioning device according to Embodiment 2.

### REFERENCE NUMERALS IN THE ACCOMPANYING DRAWINGS ARE INDICATED AS BELOW

1—casing; 101—fracturing spray hole, 102—biological agent injection hole, 103—pH adjusting liquid injection spray hole;
2—well pipe; 201—electrode limiting hole;
3—fracture;
4—electrode retraction/extending device; 401—roller; 402—compression plate; 403 sliding wheel; 404—sliding plate; 405—electrode spring;
5—reaction force tensioning device; 501—jack; 502—fixing plate; 503—support rod; 504—telescopic connecting rod; 505—connecting piece;
601—biological agent injection pump; 602—biological agent injection pipe; 603—intelligent flow control valve;
701—resistivity monitoring controller; 702—electrode line interface; 703—electrode; 704—mobile power supply; 705—current field; 706—electrode line; 801—hydraulic fracturing injection pump; 802—fracturing fluid injection pipe; 803—fracturing fluid injection valve;
901—pH injection pump; 902—pH controller; 903—pH sensor; 904—pH injection pipe; 905—pH injection valve;
1001—temperature controller; 1002—variable temperature resistor; 1003—temperature sensor; 1004—resistor regulating valve;
11—contaminated soil;
12—cable;
13—online monitoring and control system.

### SPECIFIC EMBODIMENTS

The technical solution provided by the present application will be further described below with reference to specific embodiments and the accompanying drawings. The advantages and features of the present application will become more apparent from the following description.

### EMBODIMENT 1

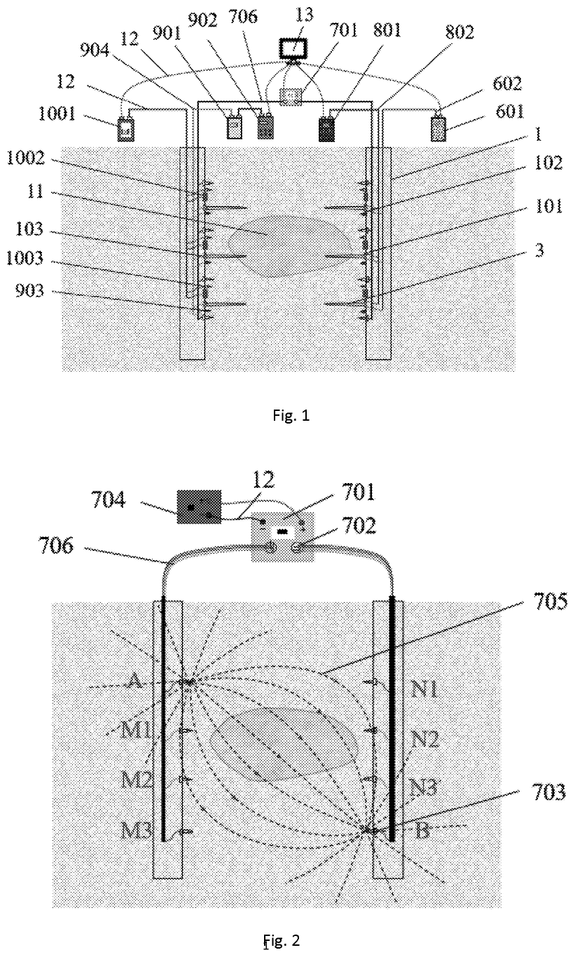

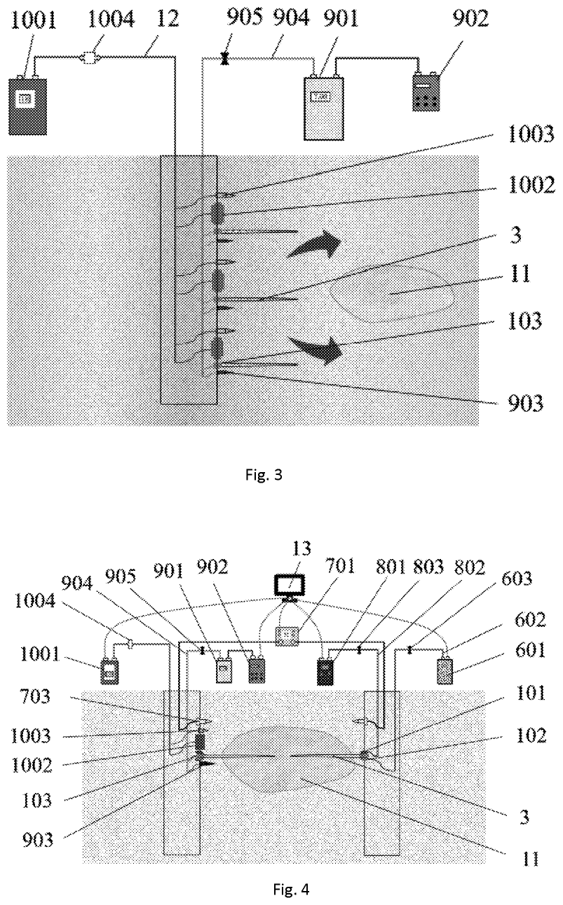

As shown in FIGS. 1 to 5, a fracturing-enhanced biodegradation remediation system for low-permeability contaminated formations comprises a casing (1), a hydraulic fracturing device, a biological agent injection device, a cross resistivity monitoring device, a pH driving device, a thermal resistance driving device, and an online monitoring and control system (13), wherein:
the casing (1) is disposed in soil of a contaminated site for preventing collapse of soil near a borehole, and a plurality of holes are opened on the casing (1) for use as injection passages for fracturing fluid, biological agent, pH adjusting liquid, and the like;
the hydraulic fracturing device is configured to create fractures (3) in the soil to provide passages for delivery of the biological agent;
the biological agent injection device is configured to deliver the biological agent through the fractures (3) to contaminated soil;
the cross resistivity monitoring device is configured to monitor resistivity changes in real time to adjust an injection amount and an injection process of the biological agent;
the pH driving device is configured to change the pH of the soil, and the thermal resistance driving device is configured to adjust the temperature of the soil, wherein microbial activity and reproduction speed are increased by the pH driving device and the thermal resistance driving device, thereby accelerating microbial decomposition of organic contaminants;
the online monitoring and control system (13) is connected to the hydraulic fracturing device, the biological agent injection device, the cross resistivity monitoring device, the pH driving device, and the thermal resistance driving device, and monitors and controls operation of the entire remediation system online.

In application, a borehole is drilled in the contaminated site and the casing (1) is inserted to prevent borehole collapse. Devices of the hydraulic fracturing device, the biological agent injection device, the pH driving device, and the thermal resistance driving device are respectively connected to the casing (1), lowered through the casing (1) into the borehole of the contaminated site, and connected to the online monitoring and control system (13), thereby completing system equipment installation. The online monitoring and control system (13) turns on the hydraulic fracturing device and injects high-pressure water and a proppant into the contaminated soil to create fractures (3). Then, the biological agent injection device injects a bioremediation agent into the fractures (3), and the cross resistivity monitoring device is used to monitor in real time the process of microbial decomposition of contaminants. The online monitoring and control system (13) precisely controls the injection amount of the biological agent based on the resistivity change information fed back by the cross resistivity monitoring device, and calls upon the pH driving device and the thermal resistance driving device to adjust the microbial living environment, thereby increasing microbial activity to accelerate contaminant decomposition.

Further, the holes opened on the casing (1) include fracturing spray holes (101), biological agent injection holes (102), and pH adjusting liquid injection spray holes (103), and further include mounting holes for installing a temperature sensor (1004), a pH sensor (903), a variable temperature resistor (1002), and electrodes (703). In practice, the number of each type of hole can be set as required.

Further, as shown in FIGS. 1 and 4, the hydraulic fracturing device comprises a hydraulic fracturing injection pump (801), a fracturing fluid injection pipe (802), and a fracturing fluid injection valve (803). The hydraulic fracturing injection pump (801) is connected to the fracturing fluid injection pipe (802), the fracturing fluid injection valve (803) is provided on the fracturing fluid injection pipe (802), and the hydraulic fracturing injection pump (801) is connected to the online monitoring and control system (13) via a cable (12) and is controlled by the online monitoring and control system (13) during the hydraulic fracturing process.

Because the high compactness of low-permeability clay severely hinders the injection of remediation agents, the hydraulic fracturing device is used to create fractures (3) as agent delivery passages. In practice, the fracturing fluid injection pipe (802) is connected to the fracturing spray holes (101) of the casing (1) to form a fracturing fluid injection passage. After opening the fracturing fluid injection valve (803), the fracturing injection pump (801) injects high-pressure water and a proppant at the fracturing spray holes (101) to form fractures (3). The fractures (3) serve as biological agent injection passages for the biological agent injection device. The proppant prevents the fractures from being compacted and re-closed under the self-weight of the soil. Using the hydraulic fracturing device solves the problem of agent injection caused by the lack of agent delivery passages due to the low porosity of low-permeability contaminated sites.

Further, as shown in FIGS. 1 and 4, the biological agent injection device comprises a biological agent injection pump (601), a biological agent injection pipe (602), and an intelligent flow control valve (603). The biological agent injection pump (601) is connected to the biological agent injection pipe (602), the intelligent flow control valve (603) is provided on the biological agent injection pipe (602), and the biological agent injection pump (601) is connected to the online monitoring and control system (13) via a cable (12) and is controlled by the online monitoring and control system (13) during the agent injection process.

Preferably, as an embodiment, the biological agent injection holes (102) can be disposed below the fracturing spray holes (101) and both are disposed near the fractures (3), so that the remediation agent can migrate along the fractures (3) created by fracturing to the contaminated area. When fracturing is performed using the hydraulic fracturing device, the biological agent injection device is turned off; when the biological agent injection device is used to inject the biological agent, the hydraulic fracturing device is turned off. In practice, the biological agent injection pipe (602) is connected to the biological agent injection holes (102) of the casing (1) to form a biological agent injection passage. The biological agent injection pump (601) delivers the biological agent through the biological agent injection pipe (602) to the biological agent injection holes (102) and then through the fractures (3) to the contaminated soil. Microorganisms in the biological agent decompose organic matter in the contaminated soil, converting organic contaminants into harmless inorganic substances, thereby achieving contaminant removal and soil remediation.

Further, as shown in FIG. 2, the cross resistivity monitoring device comprises a resistivity monitoring controller (701), an electrode line interface (702), electrode lines (706), electrodes (703), and a mobile power supply (704). The resistivity monitoring controller (701) is configured to test and analyze resistivity data and visualize a resistivity change range and is provided with the electrode line interface (702). A plurality of electrodes (703) are connected to the electrode line interface (702) via the electrode lines (706). The electrodes (703) are in contact with the soil. The mobile power supply (704) is connected to the resistivity monitoring controller (701) via a cable (12) to supply power to the resistivity monitoring controller (701). The resistivity monitoring controller (701) is connected to the online monitoring and control system (13) via a cable (12), and the resistivity monitoring controller (701) performs resistivity testing and data analysis, and further uses the online monitoring and control system (13) to regulate the biological agent injection by the biological agent injection device based on analysis results. Specifically, the number of electrodes (703) can be set as required.

The cross resistivity monitoring device uses current-supplying electrodes (A and B) to supply electricity into the ground, while observing potential differences at measuring electrodes (M1, N1, M2, N2, M3, and N3), and calculates resistivity. In the embodiment, as shown in FIG. 2, four electrodes are provided on the outside of a first casing, namely A, M1, M2, and M3; four electrodes are provided on the outside of a second casing, namely B, N1, N2, and N3; electrodes A and B serve as the current-supplying electrodes, supplying current to form a current field (705); electrodes M1, M2, M3 on the outside of the first casing and electrodes N1, N2, N3 on the outside of the second casing serve as the measuring electrodes, and resistivity is calculated from voltage values measured by any two of the measuring electrodes. The resistivity monitoring controller (701) automatically supplies electricity at regular intervals, measures voltage, and calculates resistivity data that change over time, thereby obtaining the law of resistivity change caused by contaminant degradation in the area between the two casings. The resistivity calculation formula is:

$$ρ = K \frac{Δ V}{I} \qquad ( 1 )$$

where ρ is the resistivity of the medium, l is the current intensity supplied into the ground, ΔV is the potential difference between the potential electrodes, and K is referred to as the geometric device factor, which is determined according to the relative positions of the electrodes. The expression for K is:

$$K = 2 π {\{ ( \frac{1}{AM} - \frac{1}{BM} ) - ( \frac{1}{AN} - \frac{1}{BN} ) \}}^{- 1} \qquad ( 2 )$$

where A and B represent the current-supplying electrodes, M and N represent the measuring electrodes, and AM, BM, AN, BN are the distances from the current-supplying electrodes to the measuring electrodes.

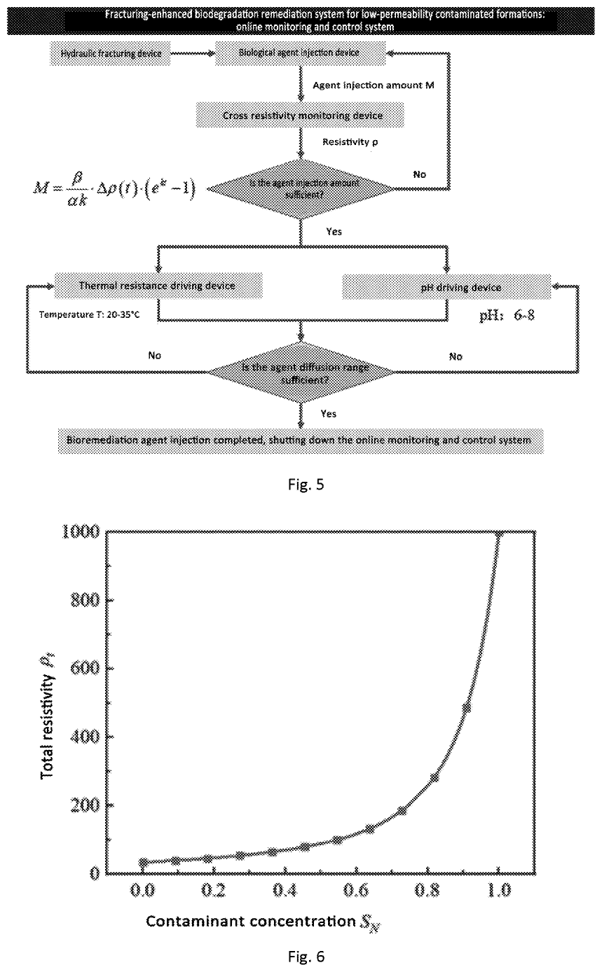

The present invention adopts a time-lapse resistivity method to monitor the contaminant degradation process. The principle of resistivity monitoring is based on a certain nonlinear relationship between resistivity and contaminant concentration. In a low-permeability clay contaminated site, microbial decomposition of contaminants leads to a decrease in contaminant concentration, and the corresponding resistivity decreases accordingly. Therefore, changes in contaminant concentration can be dynamically monitored through changes in resistivity over time. Based on Archie's law, a relationship between the contaminant concentration S_{N} in low-permeability clay and resistivity Pt is obtained:

$$ϕ ( 1 - {S}_{N} ) = {( \frac{{ρ}_{w}}{{ρ}_{t}} )}^{\frac{1}{m}} \cdot ( \frac{{ρ}_{t} - {ρ}_{r}}{{ρ}_{w} - {ρ}_{r}} ) \qquad ( 3 )$$

where φ is porosity, S_{N} is the contaminant concentration, ρ_{w} is water phase resistivity, ρₜ is total resistivity of all components, m is a cementation exponent, and ρᵣ is resistivity of soil particles. Taking the parameters of a low-permeability contaminated site as: φ=0.32, ρ_{w}=6.5, ρᵣ=1000, and m=1.5. The relationship between the contaminant concentration S_{N} and resistivity ρₜ is shown in FIG. 6.

According to Equation (3), a relationship between resistivity change and contaminant concentration change can be obtained as:

Δρₜ=α·ΔSN (4)
where α is a proportionality coefficient representing an influence of the contaminant concentration change on the resistivity change.

The microbial decomposition rate constant k is obtained by directly measuring the rate of microbial decomposition of organic contaminants through laboratory experiments, and the rate of microbial decomposition of organic contaminants can be expressed as:

$$\frac{{dS}_{N}}{dt} = - k \cdot {S}_{N} \qquad ( 5 )$$

Assuming that the total amount M of microorganisms is proportional to the total amount of decomposed contaminants, the amount of microorganisms required can be expressed as:

$$M = β \cdot {\int }_{0}^{t} {S}_{N} ( t ) dt \qquad ( 6 )$$

where β is a proportionality constant representing the amount of microorganisms required for decomposing a unit amount of contaminant.

Combining Equations (4) to (6), a relationship between the microbial injection amount M and the resistivity change Δρₜ is obtained as:

$$M = \frac{β}{α k} \cdot Δρ ( t ) \cdot ( {e}^{kt} - 1 ) \qquad ( 7 )$$

The online monitoring and control system (13) performs regulation according to the above relationship between the microbial injection amount M and the resistivity change Δρₜ, as shown in FIG. 5. Before injecting the biological agent, a resistivity test is performed once using the cross resistivity monitoring device to obtain a background initial resistivity ρ₀. After starting agent injection, resistivity tests are performed at fixed intervals (e.g., every 10 minutes) to obtain resistivity change values Δρₜ. Based on the resistivity change values Δρₜ, the contaminant decomposition rate and the remediation area are determined, and the microbial injection amount M of the biological agent injection device is adjusted according to the resistivity feedback information. That is, when the resistivity changes rapidly, it indicates a fast microbial degradation rate, and the microbial agent injection amount should be increased. Conversely, when the resistivity change is small, the microbial degradation rate of contaminants is slow, and the microbial injection amount should be reduced. By regulating the microbial injection amount M of the biological agent injection device based on the resistivity feedback information tested by the cross resistivity monitoring device, precise control of the biological agent is achieved, effectively avoiding waste caused by insufficient or excessive agent injection.

Furthermore, when the agent is delivered to areas not covered by hydraulic fracturing fractures, the agent is difficult to inject effectively. The pH driving device and the thermal resistance driving device are used to adjust the soil environment to increase microbial activity, driving microorganisms to move toward nutrients such as contaminants, thereby accelerating further microbial decomposition of organic contaminants. This remediation system can save substantial capital and time costs and effectively improve remediation efficiency.

Further, as shown in FIGS. 1, 3, and 4, the pH driving device comprises a pH injection pump (901), a pH controller (902), a pH sensor (903), a pH injection pipe (904), and a pH injection valve (905). The pH sensor (903) is disposed near and below a fracture (3). The pH controller (902) is connected to the pH sensor (903) via a cable to form a pH testing system for obtaining a pH value of a test area. The pH controller (902) is connected to the pH injection pump (901) via a cable for controlling a pH adjustment process. The pH injection pump (901) is connected to the pH injection pipe (904) and the pH injection valve (905) to form a pH adjustment system. The pH controller (902) is connected to the online monitoring and control system (13) via a cable (12), and the pH controller (902) performs pH testing and analysis, and the online monitoring and control system (13) further regulates the pH controller (902) to control pH testing and pH adjustment processes based on test results.

In practice, the pH injection pipe (904) is connected to the pH adjusting liquid injection spray holes (103) of the casing (1) to form a pH adjusting liquid injection passage. The pH injection pump (901) delivers the pH adjusting liquid through the pH injection pipe (904) to the pH adjusting liquid injection spray holes (103) and then to the contaminated soil. Since the suitable pH range for microorganisms is approximately 6 to 8, an overly acidic or overly alkaline environment inhibits microbial activity. The pH value in the soil is measured by the pH sensor (903) connected to the pH controller (902). The online monitoring and control system (13) regulates the pH controller (902) based on the measured pH information, and the pH controller (902) injects the pH adjusting liquid through the pH injection pump (901) to change the soil pH to approximately 6 to 8, thereby increasing microbial activity, accelerating microbial decomposition of organic contaminants, and speeding up remediation efficiency.

In the embodiment, the pH adjusting liquid injection spray holes (103) are located between the fracturing spray holes (101) and the biological agent injection holes (102), and all are disposed near the fractures (3) to facilitate liquid injection into the fractures (3). The pH sensor (903) is disposed below the fractures (3), and the number of pH sensors (903) can be set as required.

Further, as shown in FIGS. 1 and 4, the thermal resistance driving device comprises a temperature controller (1001), a variable temperature resistor (1002), a temperature sensor (1003), and a resistor regulating valve (1004). The variable temperature resistor (1002) and the temperature sensor (1003) are disposed near and above a fracture (3). The temperature controller (1001) is connected to the temperature sensor (1003) via a cable (12) for obtaining temperature information. The temperature controller (1001) is connected to the variable temperature resistor (1002) via a cable (12), and the resistor regulating valve (1004) is connected on the cable for controlling the variable temperature resistor (1002) to change temperature based on the temperature information. The temperature controller (1001) is connected to the online monitoring and control system (13) via a cable (12), and the online monitoring and control system (13) controls temperature testing and temperature adjustment processes.

Because microorganisms exhibit good degradation capacity within a temperature range of 20-35 °C, the temperature sensor (1003) measures the soil temperature in the contaminated area. The online monitoring and control system (13) regulates the temperature controller (1001) based on the measured temperature information, and the variable temperature resistor (1002) changes the soil temperature to adjust it as close as possible to 20-35 °C, thereby increasing microbial activity and reproduction speed, accelerating microbial decomposition of organic contaminants, and improving remediation efficiency.

In the embodiment, the variable temperature resistor (1002) and the temperature sensor (1003) are disposed above the fracture (3). The numbers of the variable temperature resistor (1002) and the temperature sensor (1003) can be set as required.

### EMBODIMENT 2

This embodiment is a further improvement of Embodiment 1.

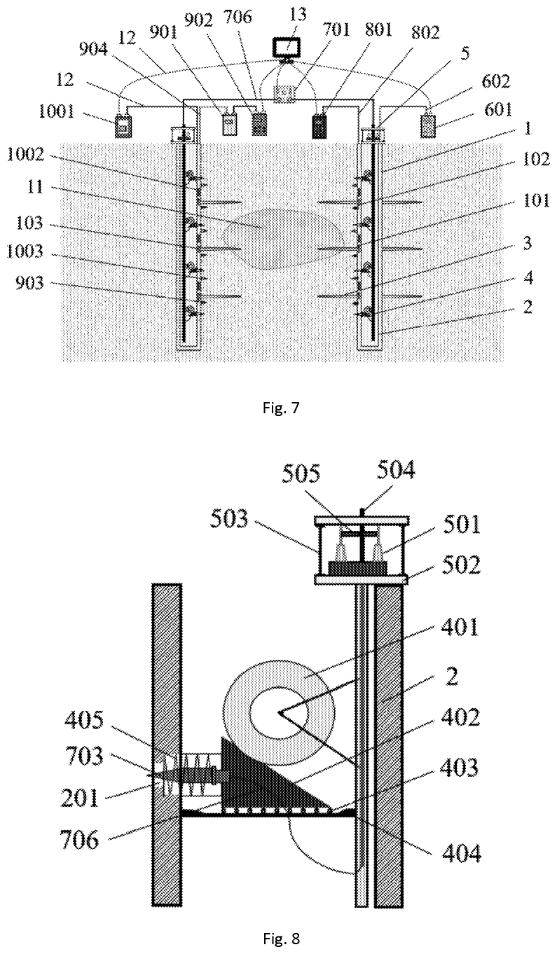

As shown in FIG. 7, a fracturing-enhanced biodegradation remediation system for low-permeability formations adds, on the basis of the fracturing-enhanced biodegradation remediation system for low-permeability contaminated formations of Embodiment 1, a well pipe (2), an electrode retraction/extending device (4), and a reaction force tensioning device (5), wherein: the well pipe (2) has an inner diameter smaller than that of the casing (1), and a plurality of electrode limiting holes (201) are opened in the middle of a side wall of the well pipe (2), and the well pipe (2) is embedded inside the casing (1);
a plurality of electrode retraction/extending devices (4) are disposed inside the well pipe (2) and connected to the well pipe (2), the electrode retraction/extending devices (4) being connected to electrodes (703), and the electrodes (703) being disposed at the electrode limiting holes (201) of the well pipe (2);
the reaction force tensioning device (5) is connected to the electrode retraction/extending devices (4) and is disposed on the ground at the top of the well pipe (2);
the well pipe (2), the electrode retraction/extending devices (4), and the reaction force tensioning device (5) are used for lowering the electrodes (703) to appropriate positions in underground boreholes, enabling insertion and extraction of the electrodes (703) into and from the soil.

The electrode retraction/extending devices (4) and the reaction force tensioning device (5) cooperate with the cross resistivity monitoring device to insert the electrodes (703) into narrow underground boreholes, thereby achieving better contact between the electrodes and the soil and obtaining stable and reliable resistivity monitoring results. Based on these results, the remediation process can be more accurately regulated. In addition, the electrode retraction/extending devices (4) and the reaction force tensioning device (5) enable recovery and reuse of the electrodes (703). After remediation is completed, the electrodes (703) and the well pipe (2) can be extracted and placed into the next underground borehole for continued use in remediation monitoring, saving substantial remediation costs and solving the problem of electrode installation in narrow monitoring wells.

Further, as shown in FIG. 8, the reaction force tensioning device (5) comprises a jack (501), fixing plates (502), support rods (503), a telescopic connecting rod (504), and a connecting piece (505). An upper fixing plate and a lower fixing plate (502) are fixedly connected by the support rods (503) to form a supporting frame. The jack (501) is disposed between the two fixing plates (502). The upper end of the telescopic connecting rod (504) is fixedly connected to the jack (501) via the connecting piece (505), and extension and compression of the jack (501) drive the telescopic connecting rod (504) to move up and down.

In the embodiment, the upper end of the telescopic connecting rod (504) is welded to the jack (501) via the connecting piece (505), and the fixing plates (502) and the support rods (503) are connected by welding.

Further, as shown in FIG. 8, the electrode retraction/extending device (4) comprises a roller (401), a compression plate (402), a sliding wheel (403), a sliding plate (404), and an electrode spring (405). The roller (401) is connected to a middle portion of the telescopic connecting rod (504) of the reaction force tensioning device (5), so that the roller (401) and the telescopic connecting rod (504) move together in the same direction. The sliding plate (404) is disposed horizontally below the roller (401) and is connected to the well pipe (2), and the sliding plate (404) is provided with a groove channel. The compression plate (402) is an inclined structural body, with its inclined surface facing the roller (401) and located below the roller (401). The sliding wheel (403) is provided at the bottom of the compression plate (402). The sliding wheel (403) is positioned within the groove channel of the sliding plate (404), allowing the compression plate (402), via the sliding wheel (403) at its bottom, to slide along the groove channel on the sliding plate (404). An electrode (703) is fixedly connected to the left end of the compression plate (402). The electrode (703) is located within the well pipe (2). The electrode spring (405) is disposed horizontally around the outside of the electrode (703), with two ends of the electrode spring (405) respectively connected to the well pipe (2) and the compression plate (402). In an initial state where the electrode (703) is not inserted into the soil, the electrode spring (405) is uncompressed and remains in a naturally extended condition. When the electrode (703) is inserted into the soil for resistivity monitoring, the electrode spring (405) remains compressed. Under the compression and rebound action of the electrode spring (405), upward and downward movement of the roller (401) drives the compression plate (402) to move left and right on the sliding plate (404), thereby driving insertion and extraction of the electrode (703).

In the embodiment, the roller (401) is welded to the middle portion of the telescopic connecting rod (504) of the reaction force tensioning device (5).

Furthermore, the electrode limiting holes (201) of the well pipe (2) are provided with grooves for fixing the positions of the electrode springs (405).

In a low-permeability contaminated soil area, a set of underground wells are drilled, and the casing (1) is lowered. The electrode retraction/extending devices (4) and the well pipe (2) are connected as an integral unit and then lowered into the casing (1). By compressing the jack (501) of the reaction force tensioning device (5), the telescopic connecting rod (504) moves downward under the action of the fixing plates (502) and the support rods (503), thereby driving the roller (401) to roll downward. As the roller (401) rolls downward, it presses the compression plate (402) to the left. The compression plate (402) moves leftward on the sliding plate (404) via the sliding wheel (403), thereby compressing the electrode spring (405). Following the movement of the compression plate (402), the electrode (703) is smoothly inserted from the narrow well into the soil, achieving stable contact between the electrode and the soil, which allows for more accurate monitoring of the bioremediation process.

When the bioremediation monitoring work is completed, the electrode retraction/extending devices (4) and the reaction force tensioning device (5) can be used to recover and reuse the electrodes (703). By extending the jack (501), since the telescopic connecting rod (504) is welded to the jack (501) via the connecting piece (505), the jack (501) drives the telescopic connecting rod (504) to move upward. As the telescopic connecting rod (504) moves upward, it causes the roller (401) to roll upward. The compression plate (402) then slides rightward under the rebound action of the electrode spring (405). Because the electrode (703) is welded to the compression plate (402), when the compression plate (402) slides rightward, it pulls the electrode (703) out of the soil, and the electrode (703) retracts back into the well pipe (2). Finally, the well pipe (2) together with the electrode retraction/extending devices (4) is extracted from the casing (1), facilitating reinstallation and reuse in the next contaminated area, saving substantial remediation costs, and effectively solving the problem that the electrodes (703) could previously only be used once.

### EMBODIMENT 3

A fracturing-enhanced biodegradation remediation method for low-permeability contaminated formations, implemented based on the remediation system of any of the above embodiments, wherein the implementation process comprises the following steps:

Step one: drilling a borehole and completing a well.

Using a drilling rig, drilling a plurality of underground wells in the contaminated site to form boreholes with a diameter of 200 mm, wherein a well spacing between adjacent underground wells is 5 to 10 m.

Step two: installing main components of the remediation system.

Passing a fracturing fluid injection pipe (802) of the hydraulic fracturing device through an inner wall of the casing (1) and connecting it to fracturing spray holes (101) via bolts to form a fracturing fluid injection passage, and connecting a hydraulic fracturing injection pump (801) to the online monitoring and control system (13) via a cable (12);
passing a biological agent injection pipe (602) of the biological agent injection device through the inner wall of the casing (1) and connecting it to biological agent injection holes (102) via bolts to form an agent injection passage, and connecting a biological agent injection pump (601) to the online monitoring and control system (13) via a cable (12);
passing a pH injection pipe (904) of the pH driving device through the inner wall of the casing (1) and connecting it to pH adjusting liquid injection spray holes (103) via bolts to form a pH adjusting liquid injection passage, and connecting a pH controller (902) to both a pH injection pump (901) and the online monitoring and control system (13) via cables (12); welding a pH sensor (903) onto the casing (1) and connecting it to the pH controller (902) via a cable (12);
welding a temperature sensor (1003) and a variable temperature resistor (1002) of the thermal resistance driving device onto the casing (1) and respectively connecting them to a temperature controller (1001) via cables (12), and connecting the temperature controller (1001) to the online monitoring and control system (13) via a cable (12);
connecting a resistivity monitoring controller (701) of the cross resistivity monitoring device to the online monitoring and control system (13) via a cable (12), connecting a plurality of electrodes (703) to an electrode line interface (702) via electrode lines (706), connecting a mobile power supply (704) to the resistivity monitoring controller (701) via a cable (12), and inserting the electrodes (703) into the soil; and placing the casing (1) into the underground well to prevent borehole collapse, and after well completion, allowing the soil to stabilize by standing for a period of time; thus, the system equipment installation is completed.

Further, for the remediation system in Embodiment 2, the electrodes (703) are inserted into the soil through the electrode holes opened on the casing (1) via the electrode limiting holes (201) of the well pipe (2), specifically as follows:
connecting the electrode retraction/extending devices to the well pipe (2), comprising: welding the sliding plate (404) to the well pipe (2), installing the sliding wheel (403) at the bottom of the compression plate (402), welding the compression plate (402) to the electrode (703) and placing the sliding wheel (403) into the groove channel of the sliding plate (404), placing the electrode spring (405) into the groove of the electrode limiting hole (201), passing the electrode (703) through the electrode spring (405) and aligning it with the electrode limiting hole (201), and welding the roller (401) to the middle portion of the telescopic connecting rod (504) of the reaction force tensioning device (5);
inserting the well pipe (2) together with the electrode retraction/extending devices (4) into the casing (1), and aligning the electrode limiting holes (201) of the well pipe (2) with the electrode holes opened on the casing (1); and
disposing the reaction force tensioning device (5) on the ground at the top of the well pipe (2), and placing the telescopic connecting rod (504) of the reaction force tensioning device (5) inside the well pipe (2); operating the jack (501) of the reaction force tensioning device (5) to compress it, causing the telescopic connecting rod (504) to move downward and drive the compression plate (402) to move leftward, thereby inserting the electrode (703) into the soil, allowing the electrode to make more stable contact with the soil.

Step three: performing hydraulic fracturing by using the hydraulic fracturing device. Ensuring that a fracturing fluid injection pipe (802) is connected to a fracturing spray hole (101), turning on a hydraulic fracturing injection pump (801) of the hydraulic fracturing device by the online monitoring and control system (13), injecting high-pressure water at the fracturing spray hole (101) to perform hydraulic fracturing, forming a fracture (3) near the fracturing spray hole (101), and delivering a high-permeability fine sand proppant into the fracture to form an agent injection passage, with a proppant injection pressure of about 600 kPa, to prevent the fracture from closing.

Step four: performing cross-hole resistivity monitoring by using the cross resistivity monitoring device.

Connecting all electrodes (703) in two underground wells respectively to an electrode line interface (702) of the cross resistivity monitoring device, connecting a mobile power supply (704) and a resistivity monitoring controller (701), controlling, by the online monitoring and control system (13), any two electrodes in the two underground wells to supply current, and the remaining any two electrodes to measure voltage, calculating a resistivity of an area between the two underground wells according to a resistivity testing principle, and monitoring once every 10 minutes, performing continuous online monitoring.

Step five: injecting remediation agent by using the biological agent injection device. Preparing a mixed liquid of a microbial agent and a growth promoter, ensuring that a biological agent injection pipe (602) is connected to a biological agent injection hole (102), turning on a biological agent injection pump (601) by the online monitoring and control system (13), injecting the microbial remediation agent through the biological agent injection pipe (602) into a fracture (3), performing resistivity monitoring based on the relationship between the microbial injection amount and the resistivity change, and using the online monitoring and control system (13) to regulate the microbial injection amount and injection rate, with an injection pressure not greater than 5 MPa to avoid affecting microbial growth.

Step six: achieving pH and temperature environment driving by using the pH driving device and the thermal resistance driving device.

Obtaining a contaminant decomposition rate and a remediation area according to resistivity monitoring results fed back by the online monitoring and control system (13), using the online monitoring and control system (13) to control a temperature sensor (1003) of the thermal resistance driving device and a pH sensor (903) of the pH driving device to respectively test ambient temperature and pH at a fracture (3), and according to pH and temperature suitable for microbial survival, turning on, by the online monitoring and control system (13), the thermal resistance driving device and the pH driving device to adjust the soil temperature and pH to 20-35 °C and 6-8, respectively, as much as possible, thereby increasing microbial activity, accelerating microbial decomposition of organic contaminants, improving remediation efficiency, and expanding a remediation range.

Step seven: performing integrated collaborative work of resistivity monitoring, bioremediation, and environment driving.

Continuing resistivity monitoring using the operation method of step four, precisely controlling the agent injection amount according to the contamination remediation situation fed back from the resistivity monitoring results, and using the pH driving device and the thermal resistance driving device to achieve pH and temperature environment driving, thereby increasing microbial activity, enhancing remediation agent migration speed, and expanding the remediation range, effectively avoiding problems such as insufficient or excessive agent injection and greatly improving remediation efficiency.

Step eight: recovering the remediation system, including important components such as the electrodes (703), the variable temperature resistor (1002), the temperature sensor (1003), the pH sensor (903), and the casing (1).

Further, for the remediation system in Embodiment 2, the electrodes (703) are recovered and reused through the electrode retraction/extending devices (4) and the reaction force tensioning device (5). Specifically, operating the jack (501) of the reaction force tensioning device (5) to extend it, the telescopic connecting rod (504) moves upward as the jack (501) extends. As the telescopic connecting rod (504) moves upward, it causes the roller (401) to roll upward. The compression plate (402) then slides rightward under the rebound action of the electrode spring (405), pulling the electrode (703) out of the soil and allowing the electrode (703) to retract back into the well pipe (2). Then, the well pipe (2) together with the electrode retraction/extending devices (4) is extracted from the casing (1). Finally, the casing (1) together with the variable temperature resistor (1002), the temperature sensor (1003), and the pH sensor (903) connected thereto is extracted from the underground well, facilitating reinstallation and reuse in the next contaminated area. By reusing these components, the remediation cost is significantly reduced.

Step nine: reinstalling the remediation system in a next borehole to carry out bioremediation.

Reinstalling the recovered components of the remediation system in other underground wells of the contaminated site, repeating steps two to eight, and using the remediation system to sequentially perform bioremediation of contaminants in different underground wells until the remediation work for all contaminated areas within the site is completed.

The above description is merely a description of preferred embodiments of the present application and is not intended to limit the scope of the present application in any way. Any changes or modifications made by a person of ordinary skill in the art based on the technical content disclosed above should be regarded as equivalent and valid embodiments and fall within the protection scope of the technical solutions of the present application.

1. A fracturing-enhanced biodegradation remediation system for low-permeability contaminated formations, comprising a casing (1), a hydraulic fracturing device, a biological agent injection device, a cross resistivity monitoring device, a pH driving device, a thermal resistance driving device, and an online monitoring and control system (13), wherein:
the casing (1) is disposed in soil of a contaminated site for preventing collapse of soil near a borehole, and a plurality of holes are opened on the casing for use as injection passages for fracturing fluid, biological agent, and pH adjusting liquid;
the hydraulic fracturing device is configured to create fractures in the soil to provide passages for delivery of the biological agent;
the biological agent injection device is configured to deliver the biological agent through the fractures to contaminated soil;
the cross resistivity monitoring device is configured to monitor resistivity changes in real time to adjust an injection amount and an injection process of the biological agent;
the pH driving device is configured to change the pH of the soil, and the thermal resistance driving device is configured to adjust the temperature of the soil, wherein microbial activity and reproduction speed are increased by the pH driving device and the thermal resistance driving device, thereby accelerating microbial decomposition of organic contaminants;
the online monitoring and control system (13) is connected to the hydraulic fracturing device, the biological agent injection device, the cross resistivity monitoring device, the pH driving device, and the thermal resistance driving device, and monitors and controls operation of the entire remediation system online;
the cross resistivity monitoring device uses current-supplying electrodes to supply electricity into the ground, while observing potential differences at measuring electrodes, and calculates resistivity;
changes in contaminant concentration are dynamically monitored through changes in resistivity over time, and a relationship between a contaminant concentration S_{N} in low-permeability clay and resistivity ρₜ is obtained based on Archie's law:
$$ϕ ( 1 - {S}_{N} ) = {( \frac{{ρ}_{w}}{{ρ}_{t}} )}^{\frac{1}{m}} \cdot ( \frac{{ρ}_{t} - {ρ}_{r}}{{ρ}_{w} - {ρ}_{r}} ) \qquad ( 3 )$$
wherein, φ is porosity, S_{N} is the contaminant concentration, ρ_{w} is water phase resistivity, ρₜ is total resistivity of all components, m is a cementation exponent, and ρᵣ is resistivity of soil particles;
a relationship between resistivity change and contaminant concentration change is obtained according to Equation (3):
Δρₜ=α·ΔS_{N} (4)
wherein, α is a proportionality coefficient representing an influence of the contaminant concentration change on the resistivity change;
a microbial decomposition rate constant k is obtained by directly measuring a rate of microbial decomposition of organic contaminants through laboratory experiments, and the rate of microbial decomposition of organic contaminants is expressed as:
$$\frac{{dS}_{N}}{dt} = - k \cdot {S}_{N} \qquad ( 5 )$$
assuming that a total amount M of microorganisms is proportional to a total amount of decomposed contaminants, an amount of microorganisms required is expressed as:
$$M = β \cdot {\int }_{0}^{t} {S}_{N} ( t ) dt \qquad ( 6 )$$
wherein, β is a proportionality constant representing an amount of microorganisms required for decomposing a unit amount of contaminant;
combining Equations (4) to (6), a relationship between a microbial injection amount M and a resistivity change Δρₜ is obtained as:
$$M = \frac{β}{α k} \cdot Δ ρ ( t ) \cdot ( {e}^{kt} - 1 ) \qquad ( 7 )$$
the online monitoring and control system (13) performs regulation according to the above relationship between the microbial injection amount M and the resistivity change Δρₜ.

2. The fracturing-enhanced biodegradation remediation system for low-permeability contaminated formations according to claim 1, wherein:
the holes opened on the casing (1) include fracturing spray holes (101), biological agent injection holes (102), and pH adjusting liquid injection spray holes (103), and further include mounting holes for installing a temperature sensor (1004), a pH sensor (903), a variable temperature resistor (1002), and electrodes (703).

3. The fracturing-enhanced biodegradation remediation system for low-permeability contaminated formations according to claim 1, wherein:
the hydraulic fracturing device comprises a hydraulic fracturing injection pump (801), a fracturing fluid injection pipe (802), and a fracturing fluid injection valve (803), wherein:
the hydraulic fracturing injection pump (801) is connected to the fracturing fluid injection pipe (802), the fracturing fluid injection valve (803) is provided on the fracturing fluid injection pipe (802), and the hydraulic fracturing injection pump (801) is connected to the online monitoring and control system (13) via a cable (12) and is controlled by the online monitoring and control system (13) during a hydraulic fracturing process.

4. The fracturing-enhanced biodegradation remediation system for low-permeability contaminated formations according to claim 1, wherein:
the biological agent injection device comprises a biological agent injection pump (601), a biological agent injection pipe (602), and an intelligent flow control valve (603), wherein:
the biological agent injection pump (601) is connected to the biological agent injection pipe (602), the intelligent flow control valve (603) is provided on the biological agent injection pipe (602), and the biological agent injection pump (601) is connected to the online monitoring and control system (13) via a cable (12) and is controlled by the online monitoring and control system (13) during an agent injection process.

5. The fracturing-enhanced biodegradation remediation system for low-permeability contaminated formations according to claim 1, wherein:
the cross resistivity monitoring device comprises a resistivity monitoring controller (701), an electrode line interface (702), electrode lines (706), electrodes (703), and a mobile power supply (704), wherein:
the resistivity monitoring controller (701) is configured to test and analyze resistivity data and visualize a resistivity change range and is provided with the electrode line interface (702); a plurality of electrodes (703) are connected to the electrode line interface (702) via the electrode lines (706); the electrodes (703) are in contact with soil; the mobile power supply (704) is connected to the resistivity monitoring controller (701) via a cable (12) to supply power to the resistivity monitoring controller (701); the resistivity monitoring controller (701) is connected to the online monitoring and control system (13) via a cable (12), and the resistivity monitoring controller (701) performs resistivity testing and data analysis, and further uses the online monitoring and control system (13) to regulate the biological agent injection by the biological agent injection device based on analysis results.

6. The fracturing-enhanced biodegradation remediation system for low-permeability contaminated formations according to claim 1, wherein:
the pH driving device comprises a pH injection pump (901), a pH controller (902), a pH sensor (903), a pH injection pipe (904), and a pH injection valve (905), wherein:
the pH sensor (903) is disposed near and below a fracture (3); the pH controller (902) is connected to the pH sensor (903) via a cable to form a pH testing system for obtaining a pH value of a test area; the pH controller (902) is connected to the pH injection pump (901) via a cable for controlling a pH adjustment process; the pH injection pump (901) is connected to the pH injection pipe (904) and the pH injection valve (905) to form a pH adjustment system; the pH controller (902) is connected to the online monitoring and control system (13) via a cable (12), and the pH controller (902) performs pH testing and analysis, and the online monitoring and control system (13) further regulates the pH controller (902) to control pH testing and pH adjustment processes based on test results.

7. The fracturing-enhanced biodegradation remediation system for low-permeability contaminated formations according to claim 1, wherein:
the thermal resistance driving device comprises a temperature controller (1001), a variable temperature resistor (1002), a temperature sensor (1003), and a resistor regulating valve (1004), wherein:
the variable temperature resistor (1002) and the temperature sensor (1003) are disposed near and above a fracture (3); the temperature controller (1001) is connected to the temperature sensor (1003) via a cable (12) for obtaining temperature information; the temperature controller (1001) is connected to the variable temperature resistor (1002) via a cable (12), and the resistor regulating valve (1004) is connected on the cable for controlling the variable temperature resistor (1002) to change temperature based on the temperature information; the temperature controller (1001) is connected to the online monitoring and control system (13) via a cable (12), and the online monitoring and control system (13) controls temperature testing and temperature adjustment processes.

8. A fracturing-enhanced biodegradation remediation method for low-permeability contaminated formations, based on the fracturing-enhanced biodegradation remediation system for low-permeability contaminated formations according to claim 1, wherein the implementation process comprises the following steps:
step one: drilling a borehole and completing a well;
step two: installing remediation system components;
step three: performing hydraulic fracturing by using the hydraulic fracturing device;
ensuring that a fracturing fluid injection pipe (802) is connected to a fracturing spray hole (101), turning on a hydraulic fracturing injection pump (801) of the hydraulic fracturing device by the online monitoring and control system (13), injecting high-pressure water at the fracturing spray hole (101) to perform hydraulic fracturing, forming a fracture (3) near the fracturing spray hole (101), and delivering a proppant into the fracture to form an agent injection passage to prevent the fracture from closing;
step four: performing cross-hole resistivity monitoring by using the cross resistivity monitoring device;
connecting all electrodes (703) in two underground wells respectively to an electrode line interface (702) of the cross resistivity monitoring device, connecting a mobile power supply (704) and a resistivity monitoring controller (701), controlling, by the online monitoring and control system (13), any two electrodes in the two underground wells to supply current, and the remaining any two electrodes to measure voltage, calculating a resistivity of an area between the two underground wells according to a resistivity testing principle, and monitoring once at fixed time intervals, performing continuous online monitoring;
step five: injecting remediation agent by using the biological agent injection device;
preparing a mixed liquid of a microbial agent and a growth promoter, ensuring that a biological agent injection pipe (602) is connected to a biological agent injection hole (102), turning on a biological agent injection pump (601) by the online monitoring and control system (13), injecting the microbial remediation agent through the biological agent injection pipe (602) into a fracture (3), performing resistivity monitoring based on the relationship between the microbial injection amount and the resistivity change, and using the online monitoring and control system (13) to regulate the microbial injection amount and injection rate;
step six: achieving pH and temperature environment driving by using the pH driving device and the thermal resistance driving device;
obtaining a contaminant decomposition rate and a remediation area according to resistivity monitoring results fed back by the online monitoring and control system (13), using the online monitoring and control system (13) to control a temperature sensor (1003) of the thermal resistance driving device and a pH sensor (903) of the pH driving device to respectively test ambient temperature and pH at a fracture (3), and according to pH and temperature suitable for microbial survival, turning on, by the online monitoring and control system (13), the thermal resistance driving device and the pH driving device to adjust soil temperature and pH, thereby increasing microbial activity, accelerating microbial decomposition of organic contaminants, improving remediation efficiency, and expanding a remediation range;
step seven: performing integrated collaborative work of resistivity monitoring, bioremediation, and environment driving;
step eight: recovering the remediation system; and
step nine: reinstalling the remediation system in a next borehole to carry out bioremediation.
